(19) United States
(12) Patent Application Publication
(10) Pub. No.: US 2013/0335409 A1
(43) Pub. Date: Dec. 19, 2013

(54) IMAGE PROCESSING APPARATUS AND IMAGE PROCESSING METHOD

(71) Applicant: KABUSHIKI KAISHA TOSHIBA, Tokyo (JP)

(72) Inventor: Koji YAMAMOTO, Ome-shi (JP)

(73) Assignee: KABUSHIKI KAISHA TOSHIBA, Tokyo (JP)

(21) Appl. No.: 13/898,856

(22) Filed: May 21, 2013

(30) Foreign Application Priority Data
Jun. 19, 2012 (JP) 2012-138183

(51) Int. Cl. G06T 15/04

(52) U.S. Cl. CPC G06T 15/04
USPC 345/419

(57) ABSTRACT

According to one embodiment, an image processing apparatus for restoring a three-dimensional shape of an object from images captured from a plurality of viewpoints, includes: a divider configured to divide a surface of a three-dimensional model to estimate the three-dimensional shape into a plurality of partial areas; a camera configured to capture images from various viewpoints of a partial area; a model generator configured to generate a reflection model based on changes of photographing angles and brightness components of the partial area; and an image generator configured to generate a texture image from which an effect of specular reflection is eliminated.

### CROSS REFERENCE TO RELATED APPLICATION(S)

The application is based upon and claims the benefit of priority from Japanese Patent Application No. 2012-138183 filed on Jun. 19, 2012, the entire contents of which are incorporated herein by reference.

### BACKGROUND

1. Field

The present invention relates to an image processing apparatus and an image processing method.

2. Description of the Related Art

Various methods have been proposed in which an image captured by photographing an object is used to create a three-dimensional model of the object. A shape from silhouette method is available as one of the methods. The shape from silhouette method is a method for estimating a three-dimensional shape of an object using a silhouette image. In the shape from silhouette method, a three-dimensional shape of an object is estimated on the basis of a silhouette constraint specifying that an object is included in a view volume in which the silhouette thereof is projected in a real space. In the shape from silhouette method, the visual hull of the view volumes corresponding to a plurality of silhouette images is calculated as the three-dimensional shape of the object. Hence, the calculated three-dimensional shape can be made similar to the shape of the object by photographing the object from various photographing positions and angles.

In the above-mentioned method, an object is required to be photographed from various photographing positions and angles to obtain an appropriate three-dimensional model. However, it is difficult for the user who is photographing the object to judge whether a sufficient amount of images has been captured to obtain an appropriate three-dimensional model. For this reason, a method has been proposed in which a three-dimensional model is generated during photographing, and when an appropriate three-dimensional model is generated, a notification stating that the photographing is completed is given to the user. This method can prevent a situation in which a sufficient amount of images for the creation of an appropriate three-dimensional model has not been obtained or a situation in which the user continues photographing although a sufficient amount of images for the creation of an appropriate three-dimensional model has already been obtained.

In the method described in Patent Document 1 relevant to the above-mentioned method, a texture and reflection parameters similar to those of a real object are obtained from a three-dimensional reconstruction in which the three-dimensional shape of an object is restored from images captured from a plurality of viewpoints. With this method, an acceptable fusion can be obtained when rendering is performed in a virtual scene together with another CG model. For this purpose, a database in which reflection parameters (diffuse reflection parameter and specular reflection parameter) are stored for each partial area of an image is used (25 of FIG. 1). The database is created beforehand when an object (an object to be photographed) that may exist in a scene during photographing is placed in an environment in which the position of the light source is known. In the figure, a plurality of video cameras are used to perform moving image photographing from a plurality of viewpoints, thereby to create a moving 3D model.

### BRIEF DESCRIPTION OF THE DRAWINGS

A general configuration that implements the various features of embodiments will be described with reference to the drawings. The drawings and the associated descriptions are provided to illustrate embodiments and not to limit the scope of the embodiments.

FIG. 1 is a perspective view showing an external appearance of an electronic device according to an embodiment of the present invention;

FIG. 2 is a block diagram showing an example of a configuration of the electronic device according to the embodiment;

FIG. 3 is a view illustrating an example of operation for generating a three-dimensional model using the electronic device according to the embodiment;

FIG. 4 is a schematic functional block diagram showing an example of an image processing apparatus according to the embodiment;

FIG. 5 is a flowchart showing a process example of the image processing apparatus according to the embodiment;

FIGS. 6A, 6B and 6C are explanatory views showing a reflection model according to the embodiment; and

FIG. 7 is a flowchart for selecting a texture image for use in another embodiment.

### DETAILED DESCRIPTION

According to one embodiment, an image processing apparatus for restoring a three-dimensional shape of an object from images captured from a plurality of viewpoints, includes: a divider configured to divide a surface of a three-dimensional model to estimate the three-dimensional shape into a plurality of partial areas; a camera configured to capture images from various viewpoints of a partial area; a model generator configured to generate a reflection model based on changes of photographing angles and brightness components of the partial area; and an image generator configured to generate a texture image from which an effect of specular reflection is eliminated.

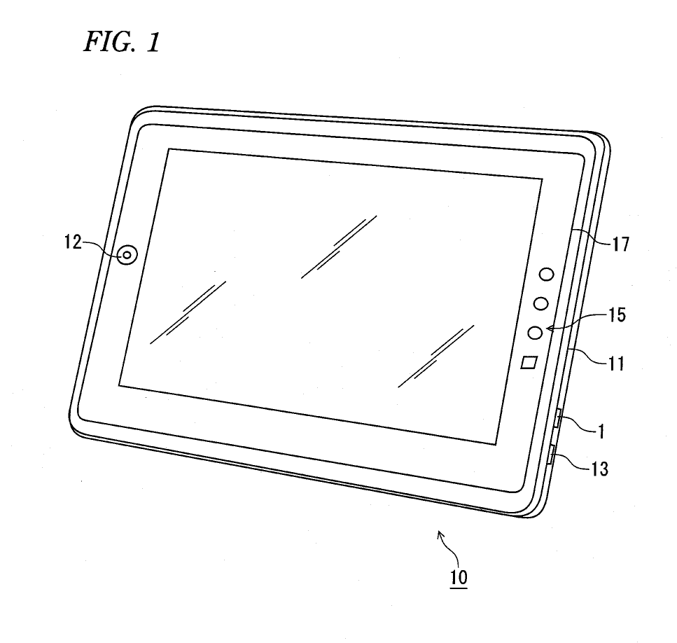

Embodiments will be described below referring to FIGS. 1 to 7.

FIG. 1 is a perspective view showing an external appearance of an electronic device according to an embodiment. This electronic device is implemented as a tablet-type personal computer (PC) 10, for example. Furthermore, this electronic device can also be implemented as a smart phone, a PDA, a notebook PC, etc. As shown in FIG. 1, the computer 10 is composed of a computer body 11 and a touch screen display 17.

The computer body 11 has a thin box-shaped housing. In the touch screen display 17, an LCD (liquid crystal display) 17A and a touch panel 17B are incorporated. The touch panel 17B is provided so as to cover the screen of the LCD 17A. The touch screen display 17 is mounted so as to be overlaid on the upper face of the computer body 11. Furthermore, a camera module 12 and an operation button group 15 are disposed at the end portion enclosing the screen of the LCD 17A. The camera module 12 may be disposed on the rear face of the computer body 11.

On the upper side face of the computer body 11, a power button for turning on/off the power source of the computer 10, a volume control button, a memory card slot, etc. are disposed. On the lower side face of the computer body 11, speakers etc. are disposed. On the right side face of the computer body 11, a USB connector 13 to which a USB cable or a USB device conforming to the USB (universal serial bus) 2.0 standard is connected and an external display connection terminal 1 conforming to the HDMI (high-definition multimedia interface) standard, for example, are provided. This external display connection terminal 1 is used to output digital video signals to an external display device. The camera module 12 may be an external camera that is connected via the USB connector 13 or the like.

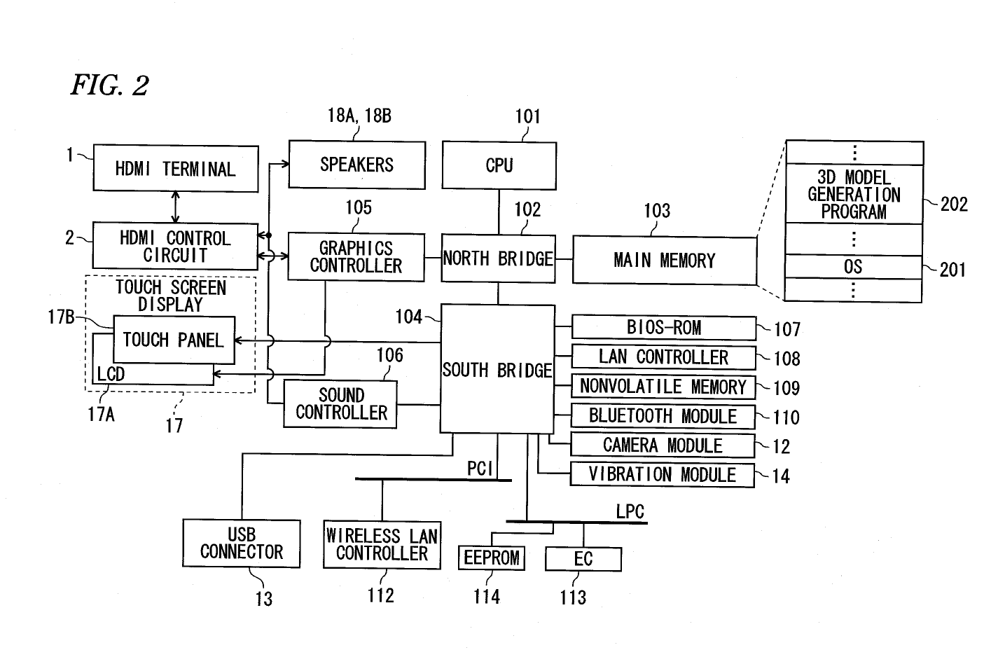

FIG. 2 is a view showing a system configuration of the computer 10.

As shown in FIG. 2, the computer 10 is equipped with a CPU 101, a north bridge 102, a main memory 103, a south bridge 104, a graphics controller 105, a sound controller 106, a BIOS-ROM 107, a LAN controller 108, a hard disk drive (HDD) 109, a Bluetooth (registered trade name) module 110, the camera module 12, a vibration module 14, a wireless LAN controller 112, an embedded controller (EC) 113, an EEPROM 114, an HDMI control circuit 2, etc.

The CPU 101 is a processor for controlling the operations of the respective sections inside the computer 10. The CPU 101 executes an operating system (OS) 201, a three-dimensional model generation program (3D model generation program) 202, various application programs, etc. these being loaded from the HDD 109 onto the main memory 103. The three-dimensional model generation program 202 has a three-dimensional model generating function that generates three-dimensional model data using images captured by the camera module 12. For example, when the user (photographer) takes a photograph of a target object (also referred to as an object), a three-dimensional model of which is to be created, from the circumference of the target object using the camera module 12, images in which the target object is photographed from various positions and angles are generated. The camera module 12 outputs the generated images to the three-dimensional model generation program 202. The three-dimensional model generation program 202 generates the three-dimensional model data of the target object using the images generated by the camera module 12. It may be possible that the three-dimensional model generation program 202 generates the three-dimensional model data of the target object using image frames included in a moving image generated by the camera module 12.

Furthermore, the CPU 101 also executes the BIOS stored in the BIOS-ROM 107. The BIOS is a program for controlling the hardware.

The north bridge 102 is a bridge device for the connection between the local bus of the CPU 101 and the south bridge 104. A memory controller for access-controlling the main memory 103 is also incorporated in the north bridge 102. In addition, the north bridge 102 has a function of performing communication with the graphics controller 105 via a serial bus conforming to the PCI EXPRESS standard, for example.

The graphics controller 105 is a display controller for controlling the LCD 17A serving as the display monitor of the computer 10. The display signal generated by the graphics controller 105 is transmitted to the LCD 17A. The LCD 17A displays an image on the basis of the display signal.

The HDMI terminal 1 is the above-mentioned external display connection terminal. The HDMI terminal 1 can transmit uncompressed digital video signals and digital audio signals to an external display device, such as a television, using a single cable. The HDMI control circuit 2 is an interface for transmitting digital video signals to an external display device referred to as an HDMI monitor via the HDMI terminal 1.

The south bridge 104 controls various devices on a PCI (Peripheral Component Interconnect) bus and various devices on an LPC (Low Pin Count) bus. In addition, the south bridge 104 incorporates an IDE (Integrated Drive Electronics) controller for controlling the HDD 109.

The south bridge 104 incorporates a USB controller for controlling the touch panel 17B. The touch panel 17B is a pointing device for input on the screen of the LCD 17A. The user can operate a graphical user interface (GUI) or the like displayed on the screen of the LCD 17A through the touch panel 17B. For example, when the user touches a button displayed on the screen, the user can instruct the execution of the function corresponding to the button. Furthermore, the USB controller executes communication to an external device via the USB 2.0 standard cable connected to the USB connector 13.

Furthermore, the south bridge 104 has a function of performing communication to the sound controller 106. The sound controller 106 is a sound source device and outputs the audio data of an object to be reproduced to speakers 18A and 18B. The LAN controller 108 is a wire communication device for executing wire communication conforming to the IEEE 802.3 standard, for example. The wireless LAN controller 112 is a wireless communication device for performing wire communication conforming to the IEEE 802.11g standard, for example. The Bluetooth (registered trade name) module 110 is a communication module for performing Bluetooth (registered trade name) communication to an external device.

The vibration module 14 is a module for generating vibration. The vibration module 14 can generate vibration of a designated magnitude.

The EC 113 is a one-chip microcomputer including an embedded controller for power management. The EC 113 has a function of turning on/off the power source of the computer 10 depending on the operation of the power button by the user.

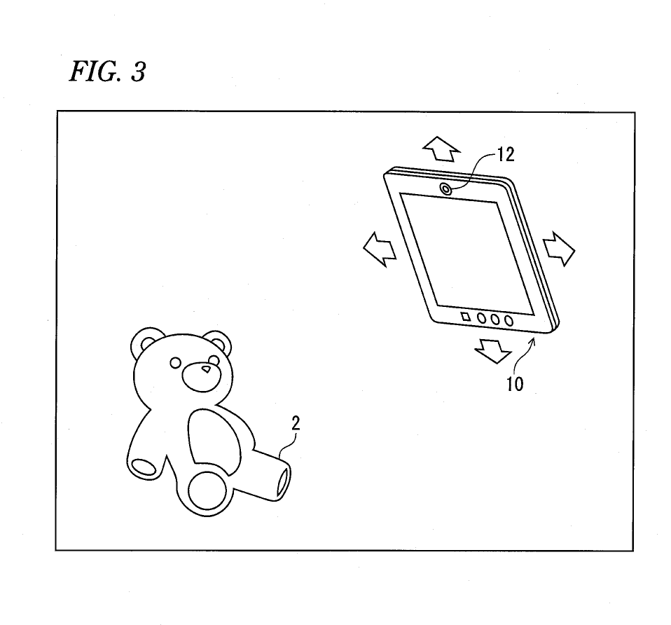

Next, FIG. 3 shows a state wherein a target object 2, a three-dimensional model of which is to be created, is photographed from the circumference thereof. The user photographs the object 2 from various positions and angles by moving the camera module 12 (the electronic device 10) around the circumference of the object 2. The three-dimensional model generation program 202 generates three-dimensional model data corresponding to the object 2 using images captured by the photographing. The three-dimensional model generation program 202 can create an excellent three-dimensional model having no missing portions because the surface of the object 2 is photographed without omission. The electronic device 10 notifies the user of the position (angle) at which the object 2 should be photographed next if necessary by means of vibration generated from the vibration module 14, sound output from the speakers 18A and 18B, information displayed on the screen of the LCD 17A, etc.

The three-dimensional model generation program 202 generates three-dimensional model data indicating the three-dimensional shape of the object 2 using a plurality of images captured by photographing the object 2. Furthermore, the three-dimensional model generation program 202 notifies the user of information relating to the position of the camera module 12 for photographing the object so that images for use in the generation of the three-dimensional model data can be captured efficiently.

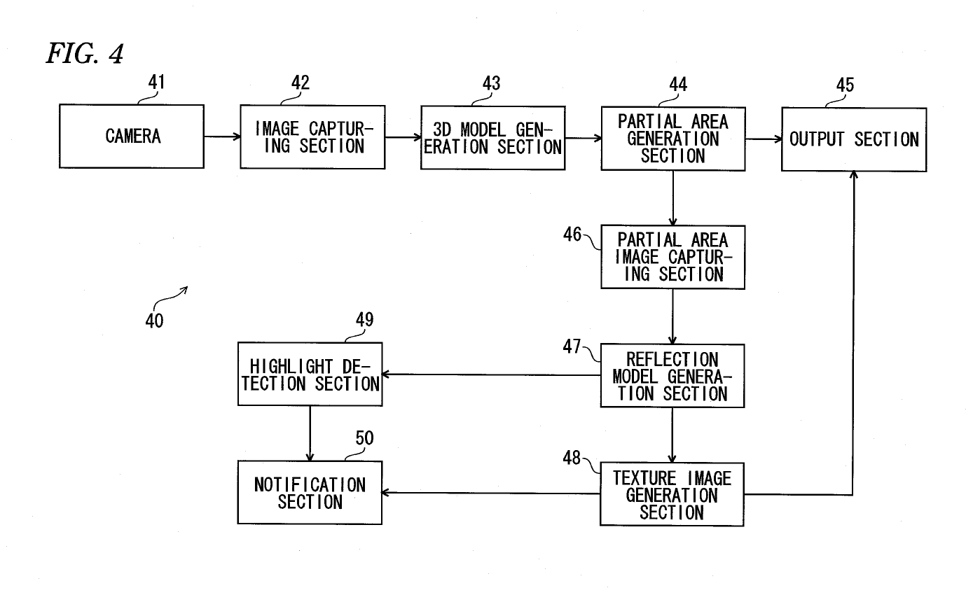

FIG. 4 is a schematic functional block diagram showing an example of an image processing apparatus according to the embodiment. This image processing apparatus 40 is equipped with a camera 41, an image capturing section 42, a 3D model generation section 43, a partial area generation section 44, an output section 45, a partial area image capturing section 46, a reflection model generation section 47, a texture image generation section 48, a highlight detection section 49, and a notification section 50.

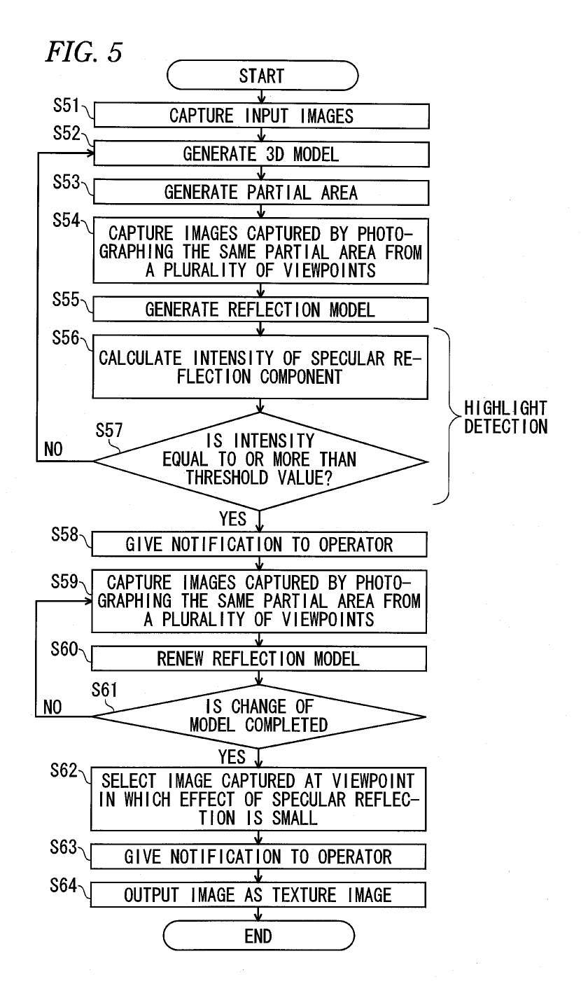

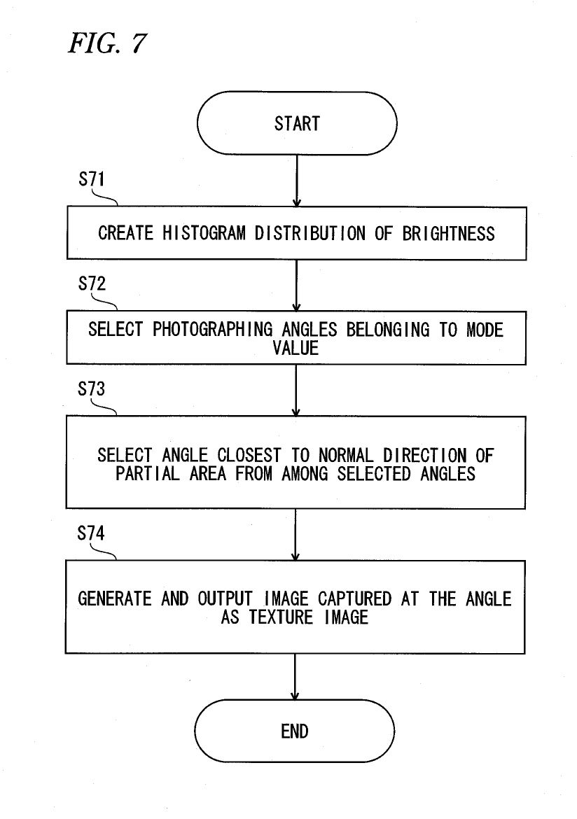

Of these sections, the camera 41 and the image capturing section 42 operate mainly depending on the camera module 12. In addition, the 3D model generation section 43 operates depending on the 3D model generation program 202. Furthermore, the partial area generation section 44 (dividing module), the partial area image capturing section 46 (capturing module), the reflection model generation section 47 (model generating module), the texture image generation section 48 (image generating module), and the highlight detection section 49 operate depending on other programs loaded onto the main memory 103. Moreover, the output section 45 operates mainly depending on the graphics controller 105, and the notification section 50 operates depending on the vibration module 14, the graphics controller 105, the sound controller 106, etc. The operations of the respective sections will be described in the explanation of the flowcharts shown in FIGS. 5 and 7.

FIG. 5 is a flowchart showing a process example of the image processing apparatus 40 according to the embodiment.

At step S51, the image capturing section 42 captures input images via the camera 41.

At step S52, the 3D model generation section 43 generates a 3D model using a conventional method. For example, the three-dimensional reconstruction method according to Patent Document 2 described above may be used.

At step S53, the partial area generation section 44 captures patches and generates a partial area.

At step S54, the partial area image capturing section 46 captures images obtained by photographing the same partial area from a plurality of viewpoints.

At step S55, the reflection model generation section 47 generates a reflection model.

At step S56, the highlight detection section 49 calculates the intensity of a specular reflection component. This intensity can be calculated, for example, by dividing the peak brightness thereof by the mode brightness, average brightness, minimum brightness, or the median value of the brightness.

At step S57, the highlight detection section 49 judges whether the intensity is equal to or more than a threshold value. If so, the processing advances to the next step. If not, the processing returns to step S52, and the above processing continues.

At step S58, the notification section 50 gives to the operator a notification stating that the operator should change the angle of the camera, for example, and perform photographing again.

At step S59, the partial area image capturing section 46 captures images obtained by photographing the same partial area from a plurality of viewpoints.

At step S60, the reflection model generation section 47 generates a reflection model.

At step S61, the reflection model generation section 47 judges whether the change of the reflection model is completed. If so, the processing advances to the next step. If not, the processing returns to step S59.

At step S62, the texture image generation section 48 selects an image captured at a viewpoint in which the effect of specular reflection is small.

At step S63, the notification section 50 gives to the operator a notification stating that the image capturing is ended (completed).

At step S64, the output section 45 outputs the image selected by the texture image generation section 48 at step S62 as a texture image.

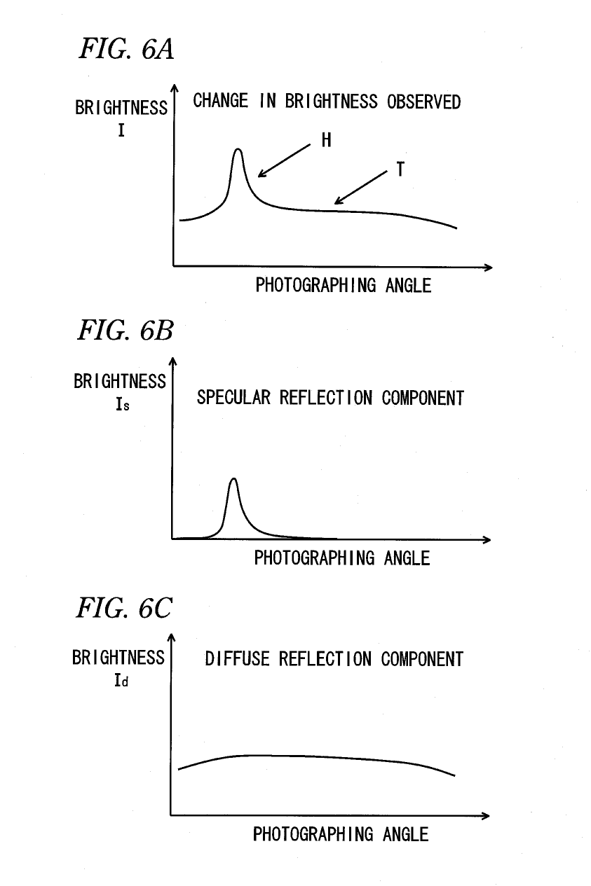

FIGS. 6A, 6B and 6C are explanatory views showing a reflection model according to the embodiment. A dichroic reflection model is represented by I=Iₛ+I_{d}, wherein I is a brightness observed, Iₛ is a specular reflection component, and Id is a diffused reflection component. FIGS. 6A, 6B and 6C respectively show the changes in brightness with respect to the photographing angle.

In FIG. 6A, the highlight portion H is a portion in which the image captured at this viewpoint is not desired to be used as the texture image. The gentle portion T is a portion in which the image captured around this viewpoint is desired to be used as the texture image.

FIGS. 6A, 6B, and 6C are views illustrating a reflection model. The reflection model generation section is not always required to strictly separate the specular reflection component from the diffused reflection component in embodying the present invention. For example, the processing shown in FIG. 7 may be used to select an image having a small specular reflection component.

In other words, FIG. 7 is a flowchart for selecting a texture image for use in another embodiment, wherein the processing of the texture image generation section 48 is mainly used.

At step S71, the reflection model generation section 47 creates a histogram distribution of brightness.

At step S72, the texture image generation section 48 selects photographing angles belonging to the mode value, for example.

At step S73, the texture image generation section 48 selects the angle closest to the normal direction of the partial area from among the selected angles (the angle is calculated from known three coordinates).

At step S74, the texture image generation section 48 generates the image captured at the angle as the texture image, and the output section 45 outputs the image.

When a three-dimensional model is created from images captured from a plurality of viewpoints as described above, a high-quality texture image having no unnecessary highlight can be generated from an unknown object. Furthermore, as described below, a notification stating that a highlight is present or that the capturing of a texture image is completed is given to the operator so that the operator is urged to perform photographing from various angles, whereby photographing can be made easy.

(1) Reflection parameters are estimated on the basis of the change in brightness at the time when the same portion of the surface of an object is photographed from various angles, whereby no database is required.

(2) A notification stating that the obtainment of the reflection parameters described above is completed is given to the photographer.

A configuration including means and functions described below can be formed.

1. An image processing apparatus for restoring the three-dimensional shape of an object from images captured from a plurality of viewpoints is configured as described below.

(1) A dividing module that is configured to divide the surface of a three-dimensional model to estimate the three-dimensional shape into a plurality of partial areas.

(2) A capturing module that is configured to capture images from various viewpoints corresponding to the respective partial areas.

(3) A model generating module that is configured to generate a reflection model depending on the changes of the photographing angles and brightness components of the respective partial areas.

(4) An image generating module that is configured to generate a texture image from which the effect of specular reflection is eliminated.

2. An image captured from the photographing angle at which the effect of the specular reflection is estimated to be smallest is selected by (3) as the texture image.

3. The intensity of the specular reflection component is calculated, and when the intensity is larger than a predetermined value, a notification stating that a highlight is present is given to the operator so that the operator is urged to photograph the highlight portion from a different angle.

4. A notification stating that the generation of the texture image is completed is given to the operator.

5. The notification described in item 4 is indicated by sound or vibration (this feature is advantageous in that the operator is not required to watch the screen).

6. The reflection parameters (the intensity of specular reflection) are recorded as additional information in the highlight detection section 49, etc. (this feature is advantageous in that an image in the case that an imaginary illumination is lit later can be estimated).

The present invention is not limited to the above-mentioned embodiments, but can be modified variously within a range not departing from the gist of the invention.

Furthermore, various inventions can be formed by appropriately combining the plurality of components disclosed in the above-mentioned embodiments. For example, some components may be omitted from all the components described in the embodiments. Moreover, components according to different embodiments may be combined appropriately.

What is claimed is:

1. An image processing apparatus for restoring a three-dimensional shape of an object from images captured from a plurality of viewpoints, comprising:
a divider configured to divide a surface of a three-dimensional model to estimate the three-dimensional shape into a plurality of partial areas;
a camera configured to capture images from various viewpoints of a partial area;
a model generator configured to generate a reflection model based on changes of photographing angles and brightness components of the partial area; and
an image generator configured to generate a texture image from which an effect of specular reflection is eliminated.

2. The image processing apparatus of claim 1, wherein
the image generator generates the texture image captured from the photographing angle at which the effect of the specular reflection is estimated to be smallest.

3. The image processing apparatus of claim 1, wherein
an intensity of an specular reflection component is calculated, and when the intensity of the component is judged to be larger than a predetermined value, a notification indicates that a highlight portion is present and the highlight portion of the object from a different angle be photographed.

4. The image processing apparatus of claim 1, further comprising
a notifier configured to give a notification indicative of the generation of the texture image being completed.

5. An image processing method in an image processing apparatus for restoring a three-dimensional shape of an object from images captured from a plurality of viewpoints, comprising:
dividing a surface of a three-dimensional model for estimating the three-dimensional shape into a plurality of partial areas;
capturing images from various viewpoints corresponding to a partial area;
generating a reflection model based on changes of photographing angles and brightness components of the partial area; and
generating a texture image from which an effect of specular reflection is eliminated.
